(19) United States
(12) Patent Application Publication
(10) Pub. No.: US 2024/0221707 A1
(43) Pub. Date: Jul. 4, 2024

(54) SYSTEMS, METHODS, AND COMPUTER PROGRAM PRODUCTS FOR GENERATING DELIBERATE SEQUENCES OF MOODS IN MUSICAL COMPOSITIONS

(71) Applicant: Obeebo Labs Ltd., Petaluma, CA (US)

(72) Inventor: Colin P. Williams, Half Moon Bay, CA (US)

(21) Appl. No.: 18/195,791

(22) Filed: May 10, 2023

Related U.S. Application Data
(60) Provisional application No. 63/340,524, filed on May 11, 2022.

(51) Int. Cl. G10H 1/00; G10H 1/46

(52) U.S. Cl. CPC G10H 1/0025; G10H 1/46; G10H 2210/061

(57) ABSTRACT

Computer-based systems, methods, and computer program products for generating musical compositions that convey intended mood sequences are described. The intended mood sequences may align with at least one scene from a movie and purposefully contribute to the mood conveyed to the audience by such at least one scene. Techniques for segmenting a movie into scenes, assigning mood labels to scenes, assigning musical characteristics to scenes based on corresponding mood labels, generating chord progressions, aligning abutting chord progressions, selecting chord inversions and root octaves, and heterogeneously reducing the volume of a musical composition at time intervals that correspond to movie dialog or other important accompanying audio features are all described.

### TECHNICAL FIELD

The present systems, computer program products, and methods generally relate to computer-generated music, and particularly relate to systems, methods, and computer program products for generating a musical composition that coveys a deliberate sequence of moods across time intervals.

### BACKGROUND

### Description of the Related Art

### Composing Musical Compositions

A musical composition may be characterized by sequences of sequential, simultaneous, and/or overlapping notes that are partitioned into one or more tracks. Starting with an original musical composition, a new musical composition or “variation” can be composed by manipulating the “elements” (e.g., notes, bars, tracks, arrangement, etc.) of the original composition. As examples, different notes may be played at the original times, the original notes may be played at different times, and/or different notes may be played at different times. Further refinements can be made based on many other factors, such as changes in musical key and scale, different choices of chords, different choices of instruments, different orchestration, changes in tempo, the imposition of various audio effects, changes to the sound levels in the mix, and so on.

In order to compose a new musical composition (or variation) based on an original or previous musical composition, it is typically helpful to have a clear characterization of the elements of the original musical composition. In addition to notes, bars, tracks, and arrangements, “segments” are also important elements of a musical composition. In this context, the term “segment” (or “musical segment”) is used to refer to a particular sequence of bars (i.e., a subset of serially-adjacent bars) that represents or corresponds to a particular section or portion of a musical composition. A musical segment may include, for example, an intro, a verse, a pre-chorus, a chorus, a bridge, a middle8, a solo, or an outro. The section or portion of a musical composition that corresponds to a “segment” may be defined, for example, by strict rules of musical theory and/or based on the sound or theme of the musical composition.

### Musical Notation

Musical notation broadly refers to any application of inscribed symbols to visually represent the composition of a piece of music. The symbols provide a way of “writing down” a song so that, for example, it can be expressed and stored by a composer and later read and performed by a musician. While many different systems of musical notation have been developed throughout history, the most common form used today is sheet music.

Sheet music employs a particular set of symbols to represent a musical composition in terms of the concepts of modern musical theory. Concepts like: pitch, rhythm, tempo, chord, key, dynamics, meter, articulation, ornamentation, and many more, are all expressible in sheet music. Such concepts are so widely used in the art today that sheet music has become an almost universal language in which musicians communicate.

### Digital Audio File Formats

While it is common for human musicians to communicate musical compositions in the form of sheet music, it is notably uncommon for computers to do so. Computers typically store and communicate music in well-established digital audio file formats, such as .mid, .wav, or .mp3 (just to name a few), that are designed to facilitate communication between electronic instruments and other computer program products by allowing for the efficient movement of musical waveforms over computer networks. In a digital audio file format, audio data is typically encoded in one of various audio coding formats (which may be compressed or uncompressed) and either provided as a raw bitstream or, more commonly, embedded in a container or wrapper format.

### BRIEF SUMMARY

A computer-implemented method of generating a musical composition to convey a sequence of moods may be summarized as including: segmenting, by a computer-based musical composition system, a movie or song into a sequence of time intervals each delimited by a respective start time and a respective stop time, wherein the computer-based musical composition system stores a set of mood labels and a set of mappings between mood labels and musical characteristics; assigning, by the computer-based musical composition system, a respective mood label to each time interval; for each time interval, assigning, by the computer-based musical composition system, at least one respective musical characteristic to the time interval based at least in part on the mood label assigned to the time interval and a stored mapping between mood labels and musical characteristics; and generating, by the computer-based musical composition system, a musical composition that includes the sequence of time intervals and each assigned musical characteristic corresponding to each time interval.

Segmenting the movie or song into a sequence of time intervals may include any or all of: identifying sequences of times of the movie or song that each delimit a respective mood; for a movie, segmenting the movie into scenes based on visual characteristics of each frame; for a movie, segmenting the movie into scenes based on audio characteristics of each frame; for a movie, segmenting the movie into scenes based on dynamic characteristics of each scene; and/or for a movie, segmenting the movie into scenes based on semantic interpretation of dialog within each scene.

Assigning, by the computer-based musical composition system, a respective mood label to each time interval may include any or all of: for a movie, assigning a respective mood label to each scene based on a distribution of colors within each scene; for a movie, assigning a respective mood label to each scene based on audio characteristics of each scene; for a movie, assigning a respective mood label to each scene based on dynamic characteristics of each scene; and/or for a movie, assigning a respective mood label to each scene based on semantic properties of each scene.

For each time interval, assigning, by the computer-based musical composition system, at least one respective musical characteristic to the time interval based at least in part on the mood label assigned to the time interval and a stored mapping between mood labels and musical characteristics may include assigning at least one respective chord progression to the time interval, the at least one chord progression selected from a set of chord progressions that correspond to the mood label assigned to the time label per the mapping between mood labels and musical characteristics. The method may further include aligning chord progressions in abutting segments of the movie or song.

The method may further include, for a movie, varying a volume of the musical composition over the time intervals to anti-correlate with a volume of the movie over the time intervals. Varying the volume of the musical composition over the time intervals to anti-correlate with a volume of the movie over the time intervals may include: partitioning the movie into a sequence of consecutive time windows; determining a mean sound volume for each time window; scaling the mean sound volume of each time window to fit in a range; determining an anti-sound volume for each time window based on the mean sound volume of each time window; adjusting a volume of the musical composition over the time windows based on the anti-sound volume of each time window; and combining the volume-adjusted musical composition with audio for the movie.

A computer program product may be summarized as including a non-transitory processor-readable storage medium storing data and/or processor-executable instructions that, when executed by at least one processor of a computer-based musical composition system, cause the computer-based musical composition system to: segment a movie or song into a sequence of time intervals each delimited by a respective start time and a respective stop time, wherein the computer-based musical composition system stores a set of mood labels and a set of mappings between mood labels and musical characteristics; assign a respective mood label to each time interval; for each time interval, assign at least one respective musical characteristic to the time interval based at least in part on the mood label assigned to the time interval and a stored mapping between mood labels and musical characteristics; and generate a musical composition that includes the sequence of time intervals and each assigned musical characteristic corresponding to each time interval.

The data and/or processor-executable instructions that, when executed by at least one processor of the computer-based musical composition system, cause the computer-based musical composition system to segment the movie or song into a sequence of time intervals, may cause the computer-based musical composition system to, for a movie, segment the movie into scenes based on visual characteristics of each frame.

The data and/or processor-executable instructions that, when executed by at least one processor of the computer-based musical composition system, cause the computer-based musical composition system to assign a respective mood label to each time interval segment the movie or song into a sequence of time intervals, may cause the computer-based musical composition system to, for a movie, assign a respective mood label to each scene based on a distribution of colors within each scene.

The data and/or processor-executable instructions that, when executed by at least one processor of the computer-based musical composition system, cause the computer-based musical composition system to, for each time interval, assign at least one respective musical characteristic to the time interval based at least in part on the mood label assigned to the time interval and a stored mapping between mood labels and musical characteristics, may cause the computer-based musical composition system to, for each time interval, assign at least one respective chord progression to the time interval, the at least one chord progression selected from a set of chord progressions that correspond to the mood label assigned to the time label per the mapping between mood labels and musical characteristics.

The computer program product may further include data and/or processor-executable instructions that, when executed by at least one processor of the computer-based musical composition system, cause the computer-based musical composition system to, for a movie, vary a volume of the musical composition over the time intervals to anti-correlate with a volume of the movie over the time intervals. The data and/or processor-executable instructions that, when executed by at least one processor of the computer-based musical composition system, cause the computer-based musical composition system to, for a movie, vary a volume of the musical composition over the time intervals to anti-correlate with a volume of the movie over the time intervals, may cause the computer-based musical composition system to: partition the movie into a sequence of consecutive time windows; determine a mean sound volume for each time window; scale the mean sound volume of each time window to fit in a range; determine an anti-sound volume for each time window based on the mean sound volume of each time window; adjust a volume of the musical composition over the time windows based on the anti-sound volume of each time window; and combine the volume-adjusted musical composition with audio for the movie.

### BRIEF DESCRIPTION OF THE SEVERAL VIEWS OF THE DRAWINGS

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIG. 1 shows an exemplary set of mood labels arranged in an exemplary 2D mood space in accordance with the present systems, computer program products, and methods.

FIG. 2 shows an exemplary 2D mood space in which warmer tones correspond to more positive polarities, cooler tones correspond to more negative polarities, deeper colors to more intensity, and paler colors to less intensity, all in accordance with the present systems, methods and computer program products.

FIG. 3 shows a set of graphs that illustrate the above process for computing and implementing an anti-sound-volume-mask in accordance with the present systems, methods, and computer program products.

FIG. 4 is a flow diagram showing a computer-implemented method of generating an aesthetic key modulation in accordance with the present systems, computer program products, and methods.

FIG. 5 is an illustrative diagram of a processor-based computer system suitable at a high level for performing the various computer-implemented methods described in the present systems, computer program products, and methods.

### DETAILED DESCRIPTION

The following description sets forth specific details in order to illustrate and provide an understanding of the various implementations and embodiments of the present systems, computer program products, and methods. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of the present systems, computer program products, and methods.

The various embodiments described herein provide systems, computer program products, and methods for generating a musical composition that coveys a deliberate sequence of moods across time intervals, e.g., to score or otherwise accompany at least one scene from a movie, or to compose a song with a particular sequence of moods/feelings/emotions across the elements of the song. Throughout this specification and the appended claims, a musical variation is considered a form of musical composition and the term “musical composition” (as in, for example, “computer-generated musical composition” and “computer-based musical composition system”) is used to include musical variations.

Systems, computer program products, and methods for encoding musical compositions in hierarchical data structures of the form Music[Segments{ }, barsPerSegment{ }] are described in U.S. Pat. No. 10,629,176, filed Jun. 21, 2019 and entitled “Systems, Computer program products, and Methods for Digital Representations of Music” (hereinafter “Hum patent”), which is incorporated by reference herein in its entirety.

Systems, computer program products, and methods for automatically identifying the musical segments of a musical composition and which can facilitate encoding musical compositions (or even simply undifferentiated sequences of musical bars) into the Music[Segments{ }, barsPerSegment{ }] form described above are described in U.S. Pat. No. 11,024,274, filed Jan. 28, 2020 and entitled “Systems, Computer program products, and Methods for Segmenting a Musical Composition into Musical Segments” (hereinafter “Segmentation patent”), which is incorporated herein by reference in its entirety.

Systems, computer program products, and methods for identifying harmonic structure in digital data structures and for mapping the Music[Segments{ }, barsPerSegment{ }] data structure into an isomorphic HarmonicStructure[Segments{ }, harmonicSequencePerSegment{ }] data structure are described in U.S. Pat. No. 11,361,741, filed Jan. 28, 2020 and entitled “Systems, Computer program products, and Methods for Harmonic Structure in Digital Representations of Music” (hereinafter “Harmony patent”), which is incorporated herein by reference in its entirety.

A movie (synonymously a film, feature, video, motion picture, animation, television show, cartoon, or similar) typically consists of a sequence of “scenes”, which are each regarded, generally, as a contiguous sequence of frames of the movie that convey a qualitatively meaningful and/or artistically coherent element of the story. Such scenes are typically set in a single location, comprise one or a series of camera shots that may or may not be from varying angles, and may or may not contain noises, dialog, sounds, or indeed no sound whatsoever (at least initially). Film makers typically tailor scenes to have a certain mood/feel/emotion. Indeed, many of the choices a director makes, such as selecting the location, clothing, colors, sounds, camera angles, and dialog used in a scene are crafted so as to create a desired mood/feeling/emotion. Another element in establishing the mood/feel/emotion of a scene comes from the music used to accompany it. In many cases, a scene absent of its music will completely fail to convey the intended mood/feel/emotion.

In the early stages of making a movie, directors often insert pre-existing music into a scene as a temporary placeholder to establish the mood/feel/emotion they desire. If a director desires to use such “temporary” placeholder music in the final cut, they would be obliged to obtain a license to do so. In many cases, the intent is to replace the temporary placeholder music with original music composed by a human musician commissioned for the purpose. Unfortunately, it is highly non-trivial to compose music that conveys a specific desired mood/feel/emotion and, in practice, many movie makers find that once they have become accustomed to hearing a particular piece of music within a scene, all subsequent compositions, even those commissioned for it, never sound quite as good. It is therefore desirable to employ a tool that enables fast and easy composition of original (optionally royalty-free) mood/feel/emotion-specific music for a scene from the outset.

The various implementations described herein include systems, methods, and computer program products for creating a musical composition that conveys a sequence of intended moods/feelings/emotions across a sequence of time intervals such as, but not limited to, time intervals delimiting the temporal boundaries of scenes within a movie, and/or time intervals delimiting the temporal boundaries of elements of a song, such as but not limited to, the “Intro”, the “Verse”, the “Pre-Chorus”, the “Chorus”, the “Bridge”, and the “Outro”, and/or similar. Such systems, methods, and computer program products can be generally applied to compose music for all scenes of a movie, or to only a subset of the scenes of a movie. Similarly, such systems, methods, and computer program products can also be generally applied compose music for all elements of a song, or to only a subset of the elements of a song.

In various implementations, time may be represented in various different ways. For example, within a movie time might be given in hours, minutes, or seconds and fractions thereof, or in terms of timecodes i.e., hour:minute:second:frame. Thus, the timecode for a movie that is shot/played back at 24 frames per second (fps) may encode 60 minutes per hour, 60 seconds per minute, and 24 frames per second (e.g., the timecode 01:12:34:16 corresponds to the 16th frame of second 34 of minute 12 of hour 1). Many movie players display time in the form of timecodes because it allows times to be specified to the granularity of individual frames. Thus, the use of timecodes can assist in synchronizing music to movies. To correctly map a timecode to actual time (i.e., hours, mins, seconds) it is necessary to know the frame rate of the movie, i.e., how many frames are displayed per second of the movie. Fortunately, movie files contain this information in their metadata. However, in other implementations time may be represented in the more conventional form of fractions of seconds, minutes, and hours (i.e., without inclusion of or reference to frames).

The present systems, methods, and computer program products for creating a musical composition conveying a sequence of intended moods/feelings/emotions across a sequence of time intervals comprise, but are not limited to, the various implementations that follow, either alone or in any combination.

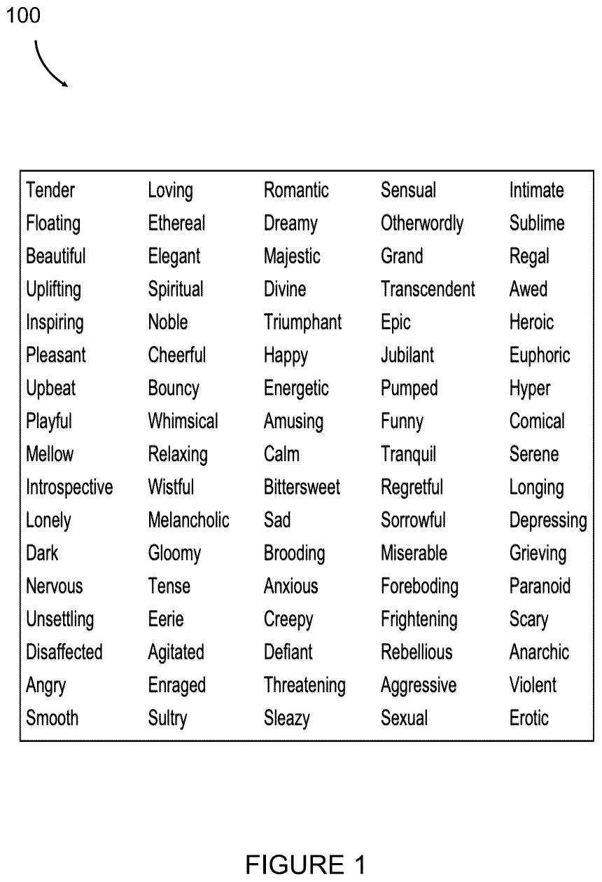

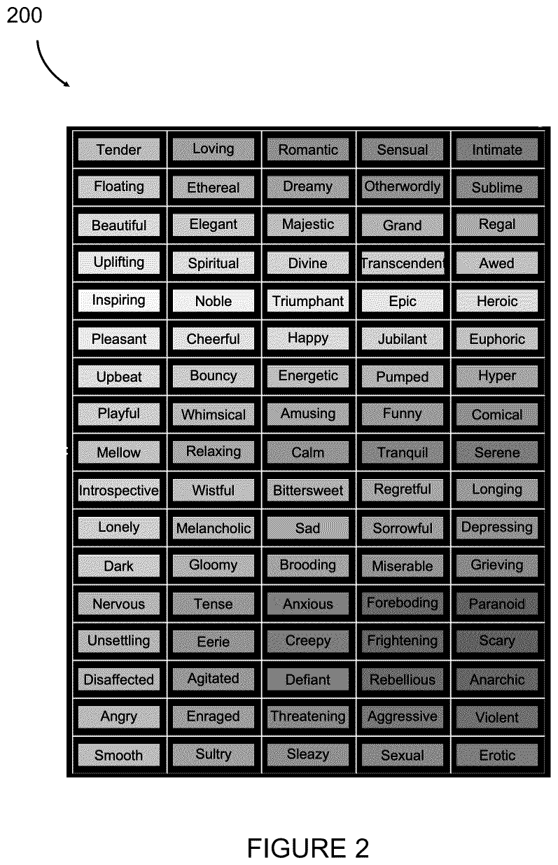

A set of mood labels that succinctly state the intended mood/feel/emotion of a scene may be employed. However, mood labels are not necessarily simple objects. The various implementations described herein allow for multiple possible representations of mood labels, including but not limited to the following:
a. 1D mood labels that represent moods as single words (e.g., “Angry”, “Sad”, “Happy”) or combinations of words (e.g., “Cheerful-Love”, “Calmly-Awaiting-Fate”). A set of 1D mood labels may include any number of labels, as a person of skill in the art will appreciate can include any/all words in a dictionary/thesaurus that may be used to characterize moods and/or emotions.
b. 2D mood labels that represent moods as coordinates in a two-dimensional mood space such as (intensity, polarity) coordinate pairs. Here, intensity is the degree to which the mood is impassioned or apathetic, and polarity is the degree to which the mood is positive or negative. With a thoughtful and precise choice of mood terms, it can be possible to map a 1D textual mood label to a 2D (intensity, polarity) coordinate pair mood label, and vice versa. FIG. 1 shows an exemplary mapping of a set of mood labels arranged in an exemplary 2D mood space 100 in accordance with the present systems, computer program products, and methods. The horizontal axis corresponds to mood intensity (increasing from left to right), and the vertical axis corresponds to mood polarity (ranging from top to bottom from positive to negative and to (somewhat) positive again). Thus, a 2D mood label is a coordinate in this 2D (intensity/polarity) space 100. In this example, “Intimate” might be modelled as the coordinate (5, 1) corresponding to column 5, row 1. In some implementations of a 2D representation of a mood space, the periodicity of the polarity, i.e., its movement from positive polarity to negative polarity and back to positive polarity, may be mapped onto the surface of a cylinder whose axial coordinate represents mood intensity and whose radial coordinate represents mood polarity. This might be of interest in the design of a graphical user interface for a computer program product and/or computer-based musical composition system in accordance with the teachings herein. Similarly, in the 2D mood label representation, color may be employed to help convey the structure of the mood space. FIG. 2 shows an exemplary 2D mood space 200 in which warmer tones correspond to more positive polarities, cooler tones correspond to more negative polarities, deeper colors to more intensity, and paler colors to less intensity. This might be of interest in the design of a graphical user interface for a computer program product and/or computer-based musical composition system in accordance with the teachings herein.
c. Higher-dimensional mood labels represent moods as coordinates in spaces of dimension greater than 2, e.g., (intensity, polarity, persistence) triples, wherein a mood such as “Shock” may correspond to a coordinate having high intensity, negative polarity, and small persistence, whereas a mood such as “Dread” may correspond to a coordinate of medium intensity, negative polarity, and large persistence. Thus, there are many possible representations of mood labels beyond simple textual labels.

Some implementations may apply the teachings of US Patent Publication 2021-0241731 (which is incorporated herein by reference in its entirety) towards the assignment of mood labels to musical compositions (or portions thereof).

As described herein, some implementations of systems, methods, and computer program products may segment a movie into a sequence of scenes each denoted by a start time and a stop time. For example, a sequence of times that delimit regions or spans of mood/emotion/feeling may be identified and/or selected. In some implementations, the selection of the temporal boundaries of one or more scenes (hereinafter called scene segmentation) may be performed manually by a human. Specifically, a user may watch a movie in a movie player that displays the time of each scene (either in hours, minutes, seconds and fractions thereof, or in timecode form). The user may record the time a scene starts and the time the scene ends. A scene may start at the beginning of one frame and end at the end of another frame. Typically, each frame may have a duration of around 1/25th to 1/30th of a second and this non-zeroness of frame duration may be taken into account when mapping from timecodes to actual time. Similarly, if a user were sketching out the timing of an intended song, the user might select temporal boundaries for the start of each successive “element” of the song (e.g., “Intro”, “Verse1”, “Chorus”, “Verse2”, “Chorus”, “Bridge”, “Chorus”, “Outro”). In this case, time might be given in absolute units (such as but not limited to seconds), or in terms of a specific number of bars in a specific tempo, and/or specific meter for each musical element.

In some implementations, scene segmentation may be performed algorithmically (e.g., by one or more computer systems) based on the visual, and/or audio, and/or dynamic, and/or semantic features of the frames of the movie. Some exemplary features of scenes that may be used for algorithmic scene segmentation include, in accordance with the present systems, methods, and computer program products:
i. The visual characteristics of a scene may include the colors used, or the faces recognized, within the frames of the scene.
ii. The audio characteristics of a scene may include the non-musical noises within the scene such as the sounds of traffic, explosions, or birdsong etc.
iii. The dynamic characteristics of a scene may include the pace of the scene as assessed by quantitative measures of the rate of change of various features contained in the scene from frame to frame. Similarly, but at a more global scale, the “pace” of a movie may be estimated as the ratio of the number of scenes in the movie to the total number of frames in the movie.
iv. The semantic characteristics of a scene may include the semantic interpretation of dialog within the scene.
   In accordance with the present systems, methods, and computer program products, scene segmentation may be performed automatically using techniques similar to those described in U.S. Pat. No. 11,024,274 (previously referenced above) to segment music into musically coherent elements. For example, a distance metric between frames of the movie may be defined and a frame may be identified as being a component of the same scene if its distance with respect to at least one preceding or succeeding frame is below some threshold. For example, considering the visual characteristics of a scene, and more specifically the facial recognition of a particular character, then even if the scene consists of a sequence of shots that jump around between the faces of different characters, thereby causing a momentary loss of facial continuity, nevertheless a given frame may be identified as belonging to the same scene as another (likely non-abutting) frame, if the same face appears within some horizon of preceding and/or succeeding frames.

The various implementations described herein include systems, methods, and computer program products to assign a mood to each scene. In some implementations, the selection of the mood for one or more scenes may be performed manually by a human. Specifically, a human watching a movie may manually select amongst an allowed set of mood labels (be they 1D textual labels, or 2D coordinate labels, or other higher dimensional mood label representations too). Such a mood assignment method relies upon the empathy and emotional intelligence of the user to determine the most fitting mood label from amongst the available choices. Note that it is entirely possible that different users may assign different mood labels to the same scene. Moreover, once music has been composed to those different mood labels and inserted into the raw unscored movie, it is entirely possible that the same scene could take on entirely different moods/feelings/emotions. This is not a bug, but rather a feature. Indeed, it would be possible to host movie-scoring competitions that would invite people to the present systems, methods, and computer program products to impose their own music moods on the same unscored movie. Similarly, in sketching the mood/emotion/feeling evolution of a song, a user might manually select the mood/emotion/feeling they desire for each successive “element” of the song. For example, if the song structure begins with the element sequence “Intro”, “Verse1”, “Chorus”, . . . the user might select the corresponding moods “Intro”/“Calm”, “Verse1”/“Introspective”, “Chorus”/“Happy”, etc.).

In some implementations, mood selection for a movie may be performed algorithmically using the visual, and/or audio, and/or dynamic, and/or semantic features of the frames of the movie. Some exemplary features of scenes that may be used for algorithmic mood selection, in accordance with the present systems, methods, and computer program products, include without limitation:
i. The mood of a scene may be inferred algorithmically from the colors, and the distribution of colors, used within a scene. Published basic science research (see for example, Jonauskaite D, Wicker J Mohr C, Dael N, Havelka J, Papadatou-Pastou M, Zhang M, Oberfeld D. 2019, “A machine learning approach to quantify the specificity of colour-emotion associations and their cultural differences”, R. Soc. open sci. 6: 190741. http://dx.doi.org/10.1098/rsos.190741) has illuminated the associations of color with mood across cultures. According to such and similar research, the general color of a scene is often correlated quite well with certain moods. For example, YELLOW is generally a positive mood (e.g., CONTENTMENT, PLEASURE, JOY), and BLACK is generally a negative, albeit more nebulous, mood (e.g., SADNESS, FEAR, HATE). Other colors (e.g., RED) tend to pick out a few moods that might even be of opposing polarity (e.g., ANGER and LOVE, in the case of RED). In such cases, other aspects of the scene, e.g., pace, as defined by for example changes per frame across adjacent frames, may be used to disambiguate mood. Nevertheless, as a crude factor, the colors of a scene, and their distribution, can be used as an automated way to estimate mood. The dominant colors of a scene may be quantified algorithmically and evaluated to estimate mood.
ii. The mood of a scene may be inferred algorithmically from the audio characteristics of the scene such as the presence of screams, or laughter, location-specific sounds such a traffic, trains, airplanes etc.
iii. The mood of a scene may be inferred algorithmically from the dynamic nature of the scene, such as its pace, as defined by for example changes per frame across adjacent frames
iv. The mood of a scene may be inferred algorithmically from the semantic characteristics of a scene, such as the semantic interpretation of dialog such as a vocalized threat, or the recognition of a specific character (hero or villain) etc.
   The present systems, methods, and computer program products include a multi-factorial approach to estimate mood wherein one or a multiplicity of the aforementioned features and/or techniques may be used to estimate the mood of each scene, and from their collective assessments an overall conclusion may be drawn. This assessment may be based on a simple majority vote of the mood/emotion/feeling label per scene, or on more sophisticated ensemble machine learning methods such as bagging and boosting.

Some implementations include systems, methods, and computer program products to map a mood label to a set of musical characteristics. Having determined the temporal scene boundaries (of a movie), or temporal element boundaries (of a song structure), and having determined the mood label per scene/per element (from a restricted set of mood labels), the mood label may be mapped to a set of musical characteristics specific to that mood label. These characteristics may include some or all of the following:
a. “Tempo” (synonymously “BPM”, “Beats per Minute” etc).
b. “Time Signature” (synonymously “Meter”).
c. “Rhythm”/“Rhythm Pattern”
d. “Instrument”/“Instrument Family” (based on, e.g., timbre, ethnicity, genre etc.)
e. “Starting Pitch”/“Approximate Starting Pitch”
f. “Ending Pitch”/“Approximate Ending Pitch”
g. “Pitch Trajectory” across the scene
h. “Starting Volume/Loudness”
i. “Ending Volume/Loudness”
j. “Volume/Loudness Trajectory” across the scene
k. “Chord Progression” (which might include information on “ChordTypes”, “ChordArpeggiations”, “ChordArticulations”, “ChordVoicing”, “ChordAddedBassNotes” etc)
l. “Genre” (i.e., music genre such as, e.g., “Rock”, “Heavy-Metal”, “Hip-Hop”, “Folk”, “Country”, “Atmospheric”, “Electronica”, etc.)
m. “Ethnicity” (i.e., music ethnicity, e.g., “Celtic”, “Bolivian”)
n. “Rhythmic Style” (e.g., “Afro-Cuban”, “Salsa”, “Marching”, etc.)
   As above, in general some or all of these characteristics may be chosen by a human, or chosen algorithmically, using the mood label alone, or in conjunction with other characteristics of the scene or song element. In some implementations, the chord progression that corresponds to the given mood label may be an advantageous characteristic to employ, as the chord progression can be an important music characteristic needed to evoke a desired mood.

Some implementations include systems, methods, and computer program products to generate chord progressions in any key and scale and in arbitrary mixed combinations of keys and scales. A chord progression is an ordered sequence of chords over time. The essential quality of a chord progression may come from the TYPES of chords used, together with their VOICINGS. Here the TYPE of a chord means how the chord is defined with respect to the scale degrees it uses. For example, a “maj” type chord uses scale degrees {1, 3, 5}, whereas a “min” type chord uses scale degrees {1, b3, 5}. Likewise, here the VOICING of a chord can mean a particular INVERSION of a chord, and/or a particular ARPEGGIATION of a chord, and/or a particular INSTRUMENTATION of a chord, and/or a particular DURATION of a chord, and/or a particular CARDINALITY of a chord (i.e., how many notes are in it), and/or a particular choice of an ADDED BASS NOTE in the chord, and/or a particular choice of an OMITTED NOTE or NOTES from the chord. In standard music theory, methods for generating aesthetic chord progressions are predominantly focused on ways to generate aesthetic chord progressions of the MAJOR and (NATURAL) MINOR scales, especially using TRIADS (i.e., 3-note chords). However, the present systems, computer program products, and methods may employ generalized methods for generating aesthetic chord progressions to (a) any KEY and SCALE, (b) to any KEY and a plurality of SCALES, (c) to any SCALE and a plurality of KEYS, and (d) to a plurality of KEYS and a plurality of SCALES. To this end, the present systems, computer program products, and methods may employ the teachings of US Patent Publication US 2021-0407477 A1 and/or US Patent Publication US 2022-0114994 A1, both of which are incorporated by reference herein in their entirety. The foregoing marks a significant expansion of music theory by allowing the highly non-standard combinations of keys and scales.

In some implementations, for any pair or KEY/SCALE used in a chord progression, and for any choice of chord note CARDINALITIES, all the chords corresponding to the given CARDINALITY/KEY/SCALE triples may be generated. Furthermore, if desired, various octaves of this set of chords may be generated and included, and in some or all INVERSIONS too. Collectively this set of chords becomes the AVAILABLE chords for planning a chord progression. In an exemplary case, the chords induced from the choice 3/C/MAJOR (meaning TRIADS of C Major) are {“C4maj”, “D4 min”, “E4 min”, “F4maj”, “G4maj”, “A4 min”, “B4dim”}, whereas 4/C/MAJOR induces the set of chords {“C4maj7”, “D4min7”, “E4min7”, “F4maj7”, “G4dom7”, “A4min7”, “B4min7b5”}. Note, in the foregoing, the integer after the note name denotes the octave of that note. More exotic key/scales are possible e.g., 3/C/JAPANESE induces the set of chords {“Bb4sus2|1”, “C4sus2b2|1”, “Bb4 min|2”, “F4sus2|1”, “G4dim| 1”} (where the notation “|1” refers to first inversion, “|2” refers to second inversion, and so on). Once the set of available chords is established, chord progressions may be generated in a variety of different ways, including without limitation as smooth chord progressions and/or as interval-constrained chord progressions.

In the case of smooth chord progressions, given an arbitrary set of available chords, a smooth chord progression may be constructed therefrom by selecting a starting chord from the available set, and thereafter recursively selecting a next chord as one having some desired range of common tone overlap with the preceding chord. In this context, common tone overlap means the number of tones shared with the preceding chord in the sequence, and tone means “a particular note regardless of octave”. Thus, for example C#2, C#3, and C#4 are common C# tones. By generating sequences of chords (e.g., from arbitrary chord sets) that have this common tone restriction, aesthetic chord progressions may be generated from arbitrary combinations of keys and scales.

In the case of interval-constrained chord progressions, given an arbitrary set of available chords, an interval-constrained chord progression may be constructed therefrom by selecting a starting chord from the available set, and thereafter recursively selecting a next chord as one having an intervallic shift in root note with respect to the preceding chord that is chosen from some set of allowed intervallic shifts. Intervallic shifts that correspond to consonant intervals may be used; however, in movie-making chord progressions that sound dissonant can also be useful. Hence, any set of intervallic shifts may be specified, not necessarily those corresponding to consonant intervals.

Some implementations include systems, methods, and computer program products to generate chord progressions evoking different moods. As examples:
a. In some implementations, chord progressions evoking a certain mood/feel/emotion may be obtained from using a specific KEY and SCALE combination. For example, mappings or associations between moods and keys/scales may be established and employed, such as: “Acceptance”->“B_NaturalMinor”, “Amorous”->“E_NaturalMinor”, “Angry”->“B_Major”, and so on.
b. In some implementations, chord progressions evoking a certain mood/feel/emotion may be obtained from using a specific MODE or SCALE (without the constraint of any specific KEY). For example, mappings or associated between moods and modes/scales may be established and employed, such as: “Algerian” (mood)->“Algerian” (scale), “Arabic” (mood)->“Arabic” (scale), “Bluesy”->{“Dorian”, “Mixolydian”}, “Bright”->“Lydian”, and so on.
c. In some implementations, chord progressions evoking a certain mood/feel/emotion may be obtained from using specific CHORD TYPES. Recall that a chord TYPE may be specified by the scale degrees it uses. Therefore, each chord TYPE could use a different chord ROOT note. However, the mood/feeling/emotion of the chord type may be relatively insensitive to which chord root is used. For example, mappings or associations between moods and chord types may be established and employed, such as: “Anxious”->“min7b5”, “Apathetic”->“sus2”, “Apprehension”->“min”, “Apprehensive”->“min7b5”, and so on. In some implementations, chord progressions evoking a certain mood/feel/emotion may be created using WEIGHTED CHORD TYPES. That is, progressions in which the relative frequencies of certain chord types are controlled. For example, mappings or associations between moods and weighted chord types may be established and employed, such as: “Excitement”->{1->“maj”} (i.e., 100% the “maj” chord type), “Craziness”->{0.8->“maj”, 0.2->“dom7”} (i.e., 80% the “maj” chord type and 20% the “dom7” chord type), “Nostalgia”->{0.6->“maj”, 0.4->“min”} (i.e., 60% the “maj” chord type and 40% the “min” chord type), and so on.
d. In some implementations, chord progressions evoking a certain mood/feel/emotion may be obtained from using specific CHORD TYPE TRANSITIONS. For example, mappings or associations between moods and chord type transitions may be established and employed, such as: “Annoying”->{“min”->“dim”, “dom9”->“min7b5”, “maj”->“min7b5”}, “Anxious Apprehension”->{“min(add9)”->“min7b5”, “dim”->“aug”, “dim”->“min”, “dim7”->“min(add9)”, “dim7”->“min7b5”, “dim7”->“add9”, “min7b5”->“dim”, “min7b5”->“dim7”, “min7b5”->“aug”, “min7b5”->“min7b5”, “min7b5”->“min7”, “min7b5”->“min6”, “min7b5”->“sus4”, “min7b5”->“dom9”, “min7b5”->“sus2”, “min7b5”->“dom7”, “min7b5”->“maj”, “min7”->“min7b5”, “min6”->“dim”, “min6”->“aug”, “min6”->“min7b5”, “min6”->“sus4”, “min6”->“maj7”, “min”->“maj9”, “min”->“maj6”, “min”->“dom7”, “min”->“maj7”, “sus4”->“dim7”, “add9”->“min7b5”, “dom9”->“dim”, “dom9”->“dim7”, “dom7”->“dim”, “dom7”->“aug”, “dom7”->“min7b5”, “maj”->“min”}, and so on.
e. In some implementations, chord progressions evoking a certain mood/feel/emotion may be obtained from using specific CHORD TYPE ALTERNATION WITH PRESCRIBED INTERVALLIC MOVEMENT. For example “min_−6_min” means going from a MINOR chord to another MINOR chord having its root note 6 half steps below that of the original chord. This transition may evoke the mood of “Danger”. Additional mappings or associations between moods and chord type alternation with prescribed intervallic movement may be established and employed, such as: “Antagonism”>{“min_−6_min”, “min_+6_min”}, “Dramatic”>{“min_+11_maj”, “min_−1_maj”}, and so on.
f. In some implementations, chord progressions evoking a certain mood/feel/emotion may be obtained from chord progressions from a certain graph of chords.

Some implementations include systems, methods, and computer program products for “aligning” the chord progressions assigned to abutting scenes/elements so as to prevent unaesthetic chord transitions at the boundaries. Given a sequence of mood-specific chord progressions, each potentially voiced with respect to different target pitch trajectories, abutting chord progressions can sometimes have unaesthetic intervallic shifts between the end of one progression and the beginning of the following progression. In accordance with the present systems, methods, and computer program products, such transitions, if musically unaesthetic, may be adjusted in several ways so as to minimize the unpleasantness. As examples:
a. In some implementations, a second chord progression may be “aligned” to a first chord progression by finding a musical intervallic shift applied to all chords of the second transition that increases the commonality of chords between the first and second progression.
b. In some implementations, a second chord progression may be “aligned” to a first chord progression by finding a key change that increases the commonality of chords between the first and second progression.
c. In some implementations, a second chord progression may be “aligned” to a first chord progression by finding a scale change that increases the commonality of chords between the first and second progression.
d. In some implementations, a second chord progression may be “aligned” to a first chord progression by finding a pivot chord, i.e., a chord that is common to the key/scale of the first progression and the key/scale of the second progression. The pivot chord can be made to be the final chord of the first progression or the first chord of the second progression. This can be accomplished, for example, by simple chord substitution or by re-generating one or both chord progressions with constraints on the starting and/or ending chords.

Some implementations include systems, methods, and computer program products for automatically choosing the inversion and root octave of a chord so as to make its root note conform to any desired pitch trajectory. Given a sequence of N chords that convey a certain mood, the various implementations described herein include systems, methods, and computer program products for how to “voice” such chords. As examples:
a. Some implementations may employ voicing that minimizes the distance between a target pitch and the lowest chord note that is above it. For example, this may be accomplished by forcing the chords to conform to a desired pitch trajectory. Specifically, given a target pitch trajectory between a starting pitch, P_1 (at a first chord) and a final pitch P_N (at a last chord), the root note and inversion of the j-th chord may be adjusted such that the distance ABOVE its lowest note and the target pitch P_i is a minimum. For example, suppose the j-th chord in a moody progression is “Amin” and the j-th target pitch value is the note “D3”, i.e., a D note in octave 3. To get a version of an “Amin” chord having its lowest note closest and above “D3”, the chord root note may be adjusted to “A3” and the chord inversion may be adjusted to 2 (i.e., second inversion). Doing so gives the voicing of “Amin” as “A3 min|2” having notes {“E3”, “A3”, “C4”}. This is the closest version of an “Amin” chord having its lowest not above “D3”.
b. Some implementations may employ voicing that minimizes the distance between a target pitch and the lowest chord note that is below it. Similarly, the voicing of the j-th chord whose lowest note is closest and below a target pitch may be constructed.
c. Some implementations may employ voicing that minimizes the distance between a target pitch and the highest chord note that is above it. Similarly, the voicing of the j-th chord whose highest note is closest and above a target pitch may be constructed.
d. Some implementations may employ voicing that minimizes the distance between a target pitch and the highest chord note that is below it. Similarly, the voicing of the j-th chord whose highest note is closest and below a target pitch may be constructed.
e. Some implementations may employ voicing that minimizes a distance between a target pitch and a chord. Similarly, the voicing of the j-th chord that minimizes a given distance measure between the notes of the chord and a given target pitch may be constructed.

Some implementations include systems, methods, and computer program products to automatically reduce the volume/loudness of the composed music so as to maintain audibility of any pre-existing dialog/noise/sound in the unscored movie. When composing music intended to be used in a film/movie/video, it may be desirable to adjust the loudness of the composed music so that, after it has been added to the film/movie/video, any dialog/noises/sounds that were already present in the (unscored) film/movie/video, or otherwise need to be clearly heard by the audience, will still be audible above the sound of the added music. In accordance with the present systems, methods, and computer program products, this may be achieved by computing an “anti-sound-volume mask” from the original (unscored) film/movie/video as follows:
i. Given the sound volumes in the video lie in the interval [VideoMin, VideoMax]
ii. Pick a desired sound volume range, [MusicMin, MusicMax], for the composed music where 0<=MusicMin<=MusicMax<=1.
iii. Partition the movie into a sequence of very short consecutive time windows, e.g., each 0.1 seconds long.
iv. Compute the mean sound volume, V_t, for each time window in the movie, t=1, 2, 3, . . . , N where N is the number of time intervals, and rescale those V_t values to lie in the range [MusicMin, MusicMax]. That is, map each sound volume in the movie, V_t, into the rescaled value V′_t=((MusicMax−MusicMin) V_t+MusicMin*VideoMax−MusicMax*VideoMin)/(VideoMax−VideoMin). These are now the values of sound loudness in the movie on a scale that runs from [MusicMin, MusicMax] as opposed to the original range [VideoMin, VideoMax].
v. Next compute the anti-sound volume, V″_t, for each of the rescaled sound volumes, V′_t using the formula V″_t=Vmax−V′_t+Vmin.
vi. Adjust the sound volume of the composed music over time window with index t to the value V″_t.
vii. Combine the audio for the movie at the original sound volumes {V_t}, with the audio for the composed music at the inverted sound volumes {V″_t}. The result makes the volume of the composed music vary in a manner that is anti-correlated with the sound volume in the original video, thereby allowing any dialog/noises/sounds in the original video to still be heard above the added composed music.

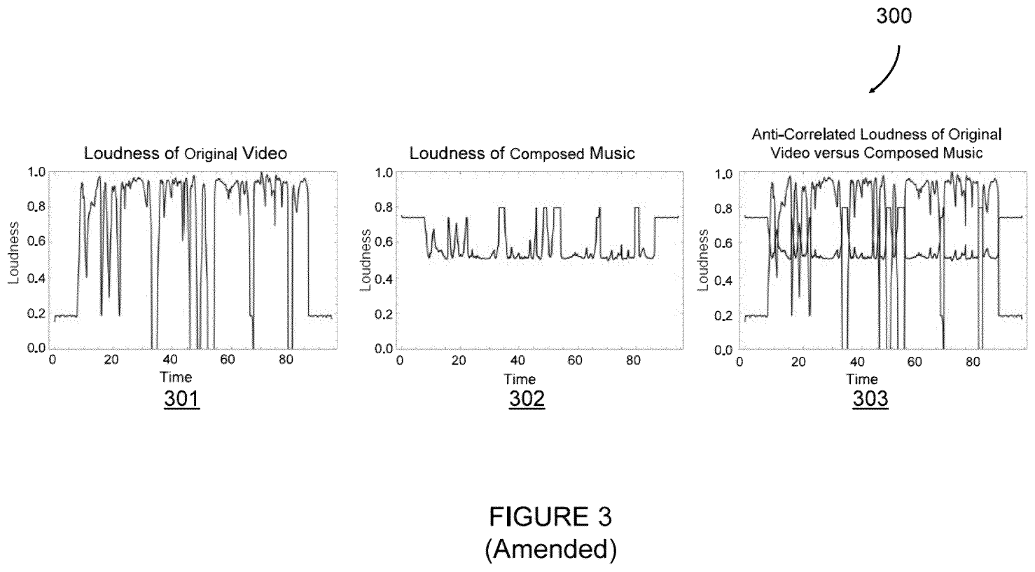

FIG. 3 shows a set of graphs 300 that illustrate the above process for computing and implementing an anti-sound-volume-mask in accordance with the present systems, methods, and computer program products. The panel on the left 301 shows the values of the original sound volume as a function of time in the range [VideoMin, VideoMax], i.e., effectively V_t for sufficiently short time windows; the central panel 302 shows the anti-sound-volume as a function of time, i.e., effectively V″_t for sufficiently short time windows; and the right hand panel 303 shows the original sound volume variation and the anti-sound-volume of the compose music superimposed.

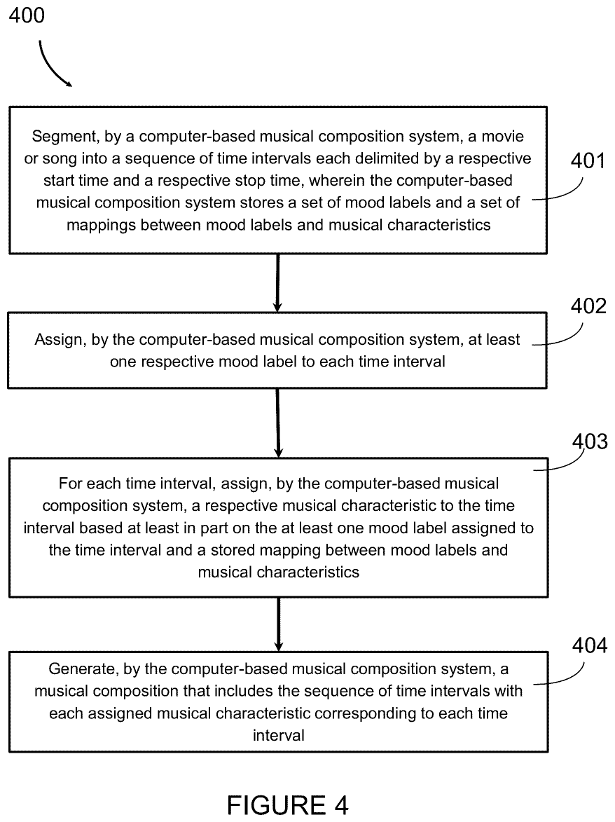

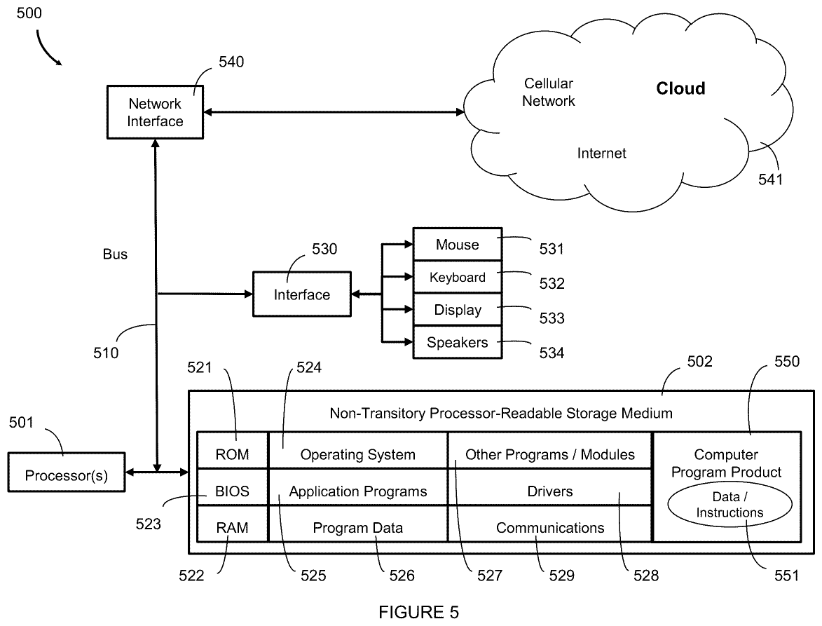

FIG. 4 is a flow diagram of a computer-implemented method 400 of generating a musical composition that conveys a sequence of intended moods across a sequence of time intervals in accordance with the present systems, computer program products, and methods. Method 400 illustrates at least some of the exemplary methods described above, and in some implementations may be deployed by a computer program product. In general, throughout this specification and the appended claims, a computer-implemented method is a method in which the various acts are performed by one or more processor-based computer system(s), such as a computer-based musical composition system. For example, certain acts of a computer-implemented method may be performed by at least one processor communicatively coupled to at least one non-transitory processor-readable storage medium or memory (hereinafter referred to as a non-transitory processor-readable storage medium) and, in some implementations, certain acts of a computer-implemented method may be performed by peripheral components of the computer system that are communicatively coupled to the at least one processor, such as interface computer program products, sensors, communications and networking hardware, and so on. The non-transitory processor-readable storage medium may store data and/or processor-executable instructions (e.g., a computer program product) that, when executed by the at least one processor, cause the computer system to perform the method and/or cause the at least one processor to perform those acts of the method that are performed by the at least one processor. FIG. 5 and the written descriptions thereof provide illustrative examples of computer systems that are suitable to perform the computer-implemented methods described herein.

Returning to FIG. 4, method 400 includes four acts 401, 402, 403, and 404, though those of skill in the art will appreciate that in alternative implementations certain acts may be omitted and/or additional acts may be added. Those of skill in the art will also appreciate that the illustrated order of the acts is shown for exemplary purposes only and may change in alternative implementations.

At 401, the computer-based musical composition system segments a movie or song into a sequence of time intervals each delimited by a respective start time and a respective stop time as described herein. The computer-based musical composition system stores a set of mood labels and a set of mappings between mood labels and musical characteristics. In the case where a song is being segmented, the song may be an existing song that is processed and segmented, e.g., according to the teachings of Segmentation patent; however, in some implementations the song may not yet exist, and segmenting the song may involve planning out the segments of the song as a framework (i.e., input) for method 400 to generate a musical composition within the planned segments.

At 402, the computer-based musical composition system assigns at least one respective mood label to each time interval as described herein.

At 403, for each time interval the computer-based musical composition system assigns a respective musical characteristic to the time interval based at least in part on the at least one mood label assigned to the time interval and a stored mapping between mood labels and musical characteristics as described herein. Exemplary musical characteristics may include notes, chords, chord progressions, or similar as described herein.

At 404, the computer-based musical composition system generates a musical composition that includes the sequence of time intervals and each assigned musical characteristic corresponding to each time interval. In some implementations, the computer-based musical composition system may automatically adjust the volume of the musical composition at various time intervals in order to, for example, enable other audio features of the accompanying movie or song to be better heard by the listener as described herein.

The various implementations described herein often make reference to “computer-based,” “computer-implemented,” “at least one processor,” “a non-transitory processor-readable storage medium,” and similar computer-oriented terms. A person of skill in the art will appreciate that the present systems, computer program products, and methods may be implemented using or in association with a wide range of different hardware configurations, including localized hardware configurations (e.g., a desktop computer, laptop, smartphone, or similar) and/or distributed hardware configurations that employ hardware resources located remotely relative to one another and communicatively coupled through a network, such as a cellular network or the internet. For the purpose of illustration, exemplary computer systems suitable for implementing the present systems, computer program products, and methods are provided in FIG. 5.

FIG. 5 is an illustrative diagram of an exemplary computer-based musical composition system 500 suitable at a high level for performing the various computer-implemented methods described in the present systems, computer program products, and methods. Although not required, some portion of the implementations are described herein in the general context of data, processor-executable instructions or logic, such as program application modules, objects, or macros executed by one or more processors. Those skilled in the art will appreciate that the described implementations, as well as other implementations, can be practiced with various processor-based system configurations, including handheld computer program products, such as smartphones and tablet computers, multiprocessor systems, microprocessor-based or programmable consumer electronics, personal computers (“PCs”), network PCs, minicomputers, mainframe computers, and the like.

Computer-based musical composition system 500 includes at least one processor 501, a non-transitory processor-readable storage medium or “system memory” 502, and a system bus 510 that communicatively couples various system components including the system memory 502 to the processor(s) 501. Computer-based musical composition system 500 is at times referred to in the singular herein, but this is not intended to limit the implementations to a single system, since in certain implementations there will be more than one system or other networked computing device(s) involved. Non-limiting examples of commercially available processors include, but are not limited to: Core microprocessors from Intel Corporation, U.S.A., PowerPC microprocessor from IBM, ARM processors from a variety of manufacturers, Sparc microprocessors from Sun Microsystems, Inc., PA-RISC series microprocessors from Hewlett-Packard Company, and 68xxx series microprocessors from Motorola Corporation.

The processor(s) 501 of computer-based musical composition system 500 may be any logic processing unit, such as one or more central processing units (CPUs), microprocessors, digital signal processors (DSPs), application-specific integrated circuits (ASICs), field programmable gate arrays (FPGAs), and/or the like. Unless described otherwise, the construction and operation of the various blocks shown in FIG. 5 may be presumed to be of conventional design. As a result, such blocks need not be described in further detail herein as they will be understood by those skilled in the relevant art.

The system bus 510 in the computer-based musical composition system 500 may employ any known bus structures or architectures, including a memory bus with memory controller, a peripheral bus, and/or a local bus. The system memory 502 includes read-only memory (“ROM”) 521 and random access memory (“RAM”) 522. A basic input/output system (“BIOS”) 523, which may or may not form part of the ROM 521, may contain basic routines that help transfer information between elements within computer-based musical composition system 500, such as during start-up. Some implementations may employ separate buses for data, instructions and power.

Computer-based musical composition system 500 (e.g., system memory 502 thereof) may include one or more solid state memories, for instance, a Flash memory or solid state drive (SSD), which provides nonvolatile storage of processor-executable instructions, data structures, program modules and other data for computer-based musical composition system 500. Although not illustrated in FIG. 5, computer-based musical composition system 500 may, in alternative implementations, employ other non-transitory computer- or processor-readable storage media, for example, a hard disk drive, an optical disk drive, or a memory card media drive.

Program modules in computer-based musical composition system 500 may be stored in system memory 502, such as an operating system 524, one or more application programs 525, program data 526, other programs or modules 527, and drivers 528.

The system memory 502 in computer-based musical composition system 500 may also include one or more communications program(s) 529, for example, a server and/or a Web client or browser for permitting computer-based musical composition system 500 to access and exchange data with other systems such as user computing systems, Web sites on the Internet, corporate intranets, or other networks as described below. The communications program(s) 529 in the depicted implementation may be markup language based, such as Hypertext Markup Language (HTML), Extensible Markup Language (XML) or Wireless Markup Language (WML), and may operate with markup languages that use syntactically delimited characters added to the data of a document to represent the structure of the document. A number of servers and/or Web clients or browsers are commercially available such as those from Google (Chrome), Mozilla (Firefox), Apple (Safari), and Microsoft (Internet Explorer).

While shown in FIG. 5 as being stored locally in system memory 502, operating system 524, application programs 525, program data 526, other programs/modules 527, drivers 528, and communication program(s) 529 may be stored and accessed remotely through a communication network or stored on any other of a large variety of non-transitory processor-readable media (e.g., hard disk drive, optical disk drive, SSD and/or flash memory).

Computer-based musical composition system 500 may include one or more interface(s) to enable and provide interactions with a user, peripheral device(s), and/or one or more additional processor-based computer system(s). As an example, computer-based musical composition system 500 includes interface 530 to enable and provide interactions with a user of computer-based musical composition system 500. A user of computer-based musical composition system 500 may enter commands, instructions, data, and/or information via, for example, input computer program products such as computer mouse 531 and keyboard 532. Other input computer program products may include a microphone, joystick, touch screen, game pad, tablet, scanner, biometric scanning device, wearable input device, and the like. These and other input computer program products (i.e., “I/O computer program products”) are communicatively coupled to processor(s) 501 through interface 530, which may include one or more universal serial bus (“USB”) interface(s) that communicatively couples user input to the system bus 510, although other interfaces such as a parallel port, a game port or a wireless interface or a serial port may be used. A user of computer-based musical composition system 500 may also receive information output by computer-based musical composition system 500 through interface 530, such as visual information displayed by a display 533 and/or audio information output by one or more speaker(s) 534. Monitor 533 may, in some implementations, include a touch screen.

As another example of an interface, computer-based musical composition system 500 includes network interface 540 to enable computer-based musical composition system 500 to operate in a networked environment using one or more of the logical connections to communicate with one or more remote computers, servers and/or computer program products (collectively, the “Cloud” 541) via one or more communications channels. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, network interface 540 may include one or more wired or wireless communications interfaces, such as network interface controllers, cellular radios, WI-FI radios, and/or Bluetooth radios for establishing communications with the Cloud 541, for instance, the Internet or a cellular network.

In a networked environment, program modules, application programs or data, or portions thereof, can be stored in a server computing system (not shown). Those skilled in the relevant art will recognize that the network connections shown in FIG. 5 are only some examples of ways of establishing communications between computers, and other connections may be used, including wirelessly.

For convenience, processor(s) 501, system memory 502, interface 530, and network interface 540 are illustrated as communicatively coupled to each other via the system bus 510, thereby providing connectivity between the above-described components. In alternative implementations, the above-described components may be communicatively coupled in a different manner than illustrated in FIG. 5. For example, one or more of the above-described components may be directly coupled to other components, or may be coupled to each other via intermediary components (not shown). In some implementations, system bus 510 may be omitted with the components all coupled directly to each other using suitable connections.

In accordance with the present systems, computer program products, and methods, computer-based musical composition system 500 may be used to implement or in association with any or all of the methods and/or acts described herein, including but not limited to method 400, and/or to encode, manipulate, vary, and/or generate any or all of the musical compositions described herein. Generally, computer-based musical composition system 500 may be deployed or leveraged to generate aesthetic chord progressions and key modulations as described throughout this specification and the appended claims. Where the descriptions of the acts or methods herein make reference to an act being performed by at least one processor or more generally by a computer-based musical composition system, such act may be performed by processor(s) 501 and/or system memory 502 of computer system 500.

Computer system 500 is an illustrative example of a system for performing all or portions of the various methods described herein, the system comprising at least one processor 501, at least one non-transitory processor-readable storage medium 502 communicatively coupled to the at least one processor 501 (e.g., by system bus 510), and the various other hardware and software components illustrated in FIG. 5 (e.g., operating system 524, mouse 531, etc.). In particular, in order to enable system 500 to implement the present systems, computer program products, and methods, system memory 502 stores a computer program product 550 comprising processor-executable instructions and/or data 551 (e.g., mood labels, a set of mappings between mood labels and musical characteristics, and the like) that, when executed by processor(s) 501, cause processor(s) 501 to perform the various acts of methods that are performed by a computer-based musical composition system, including but not limited to method 400.

Throughout this specification and the appended claims, the term “computer program product” is used to refer to a package, combination, or collection of software comprising processor-executable instructions and/or data that may be accessed by (e.g., through a network such as cloud 541) or distributed to and installed on (e.g., stored in a local non-transitory processor-readable storage medium such as system memory 502) a computer system (e.g., computer system 500) in order to enable certain functionality (e.g., application(s), program(s), and/or module(s)) to be executed, performed, or carried out by the computer system.

Throughout this specification and the appended claims, reference is often made to musical compositions being “automatically” generated/composed by computer-based algorithms, software, and/or artificial intelligence (AI) techniques. A person of skill in the art will appreciate that a wide range of algorithms and techniques may be employed in computer-generated music, including without limitation: algorithms based on mathematical models (e.g., stochastic processes), algorithms that characterize music as a language with a distinct grammar set and construct compositions within the corresponding grammar rules, algorithms that employ translational models to map a collection of non-musical data into a musical composition, evolutionary methods of musical composition based on genetic algorithms, and/or machine learning-based (or AI-based) algorithms that analyze prior compositions to extract patterns and rules and then apply those patterns and rules in new compositions. These and other algorithms may be advantageously adapted to exploit the features and techniques enabled by the digital representations of music described herein.

Throughout this specification and the appended claims the term “communicative” as in “communicative coupling” and in variants such as “communicatively coupled,” is generally used to refer to any engineered arrangement for transferring and/or exchanging information. For example, a communicative coupling may be achieved through a variety of different media and/or forms of communicative pathways, including without limitation: electrically conductive pathways (e.g., electrically conductive wires, electrically conductive traces), magnetic pathways (e.g., magnetic media), wireless signal transfer (e.g., radio frequency antennae), and/or optical pathways (e.g., optical fiber). Exemplary communicative couplings include, but are not limited to: electrical couplings, magnetic couplings, radio frequency couplings, and/or optical couplings.

Throughout this specification and the appended claims, infinitive verb forms are often used. Examples include, without limitation: “to encode,” “to provide,” “to store,” and the like. Unless the specific context requires otherwise, such infinitive verb forms are used in an open, inclusive sense, that is as “to, at least, encode,” “to, at least, provide,” “to, at least, store,” and so on.

This specification, including the drawings and the abstract, is not intended to be an exhaustive or limiting description of all implementations and embodiments of the present systems, computer program products, and methods. A person of skill in the art will appreciate that the various descriptions and drawings provided may be modified without departing from the spirit and scope of the disclosure. In particular, the teachings herein are not intended to be limited by or to the illustrative examples of computer systems and computing environments provided.

This specification provides various implementations and embodiments in the form of block diagrams, schematics, flowcharts, and examples. A person skilled in the art will understand that any function and/or operation within such block diagrams, schematics, flowcharts, or examples can be implemented, individually and/or collectively, by a wide range of hardware, software, and/or firmware. For example, the various embodiments disclosed herein, in whole or in part, can be equivalently implemented in one or more: application-specific integrated circuit(s) (i.e., ASICs); standard integrated circuit(s); computer program(s) executed by any number of computers (e.g., program(s) running on any number of computer systems); program(s) executed by any number of controllers (e.g., microcontrollers); and/or program(s) executed by any number of processors (e.g., microprocessors, central processing units, graphical processing units), as well as in firmware, and in any combination of the foregoing.

Throughout this specification and the appended claims, a “memory” or “storage medium” is a processor-readable medium that is an electronic, magnetic, optical, electromagnetic, infrared, semiconductor, or other physical device or means that contains or stores processor data, data objects, logic, instructions, and/or programs. When data, data objects, logic, instructions, and/or programs are implemented as software and stored in a memory or storage medium, such can be stored in any suitable processor-readable medium for use by any suitable processor-related instruction execution system, apparatus, or device, such as a computer-based system, processor-containing system, or other system that can fetch the data, data objects, logic, instructions, and/or programs from the memory or storage medium and perform various acts or manipulations (i.e., processing steps) thereon and/or in response thereto. Thus, a “non-transitory processor-readable storage medium” can be any element that stores the data, data objects, logic, instructions, and/or programs for use by or in connection with the instruction execution system, apparatus, and/or device. As specific non-limiting examples, the processor-readable medium can be: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and/or any other non-transitory medium.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A computer-implemented method of generating a musical composition to convey a sequence of moods, the method comprising:
segmenting, by a computer-based musical composition system, a movie or song into a sequence of time intervals each delimited by a respective start time and a respective stop time, wherein the computer-based musical composition system stores a set of mood labels and a set of mappings between mood labels and musical characteristics;
assigning, by the computer-based musical composition system, a respective mood label to each time interval;
for each time interval, assigning, by the computer-based musical composition system, at least one respective musical characteristic to the time interval based at least in part on the mood label assigned to the time interval and a stored mapping between mood labels and musical characteristics; and
generating, by the computer-based musical composition system, a musical composition that includes the sequence of time intervals and each assigned musical characteristic corresponding to each time interval.

2. The method of claim 1 wherein segmenting the movie or song into a sequence of time intervals includes identifying sequences of times of the movie or song that each delimit a respective mood.

3. The method of claim 1 wherein segmenting the movie or song into a sequence of time intervals includes, for a movie, segmenting the movie into scenes based on visual characteristics of each frame.

4. The method of claim 1 wherein segmenting the movie or song into a sequence of time intervals includes, for a movie, segmenting the movie into scenes based on audio characteristics of each frame.

5. The method of claim 1 wherein segmenting the movie or song into a sequence of time intervals includes, for a movie, segmenting the movie into scenes based on dynamic characteristics of each scene.

6. The method of claim 1 wherein segmenting the movie or song into a sequence of time intervals includes, for a movie, segmenting the movie into scenes based on semantic interpretation of dialog within each scene.

7. The method of claim 1 wherein assigning, by the computer-based musical composition system, a respective mood label to each time interval includes, for a movie, assigning a respective mood label to each scene based on a distribution of colors within each scene.

8. The method of claim 1 wherein assigning, by the computer-based musical composition system, a respective mood label to each time interval includes, for a movie, assigning a respective mood label to each scene based on audio characteristics of each scene.

9. The method of claim 1 wherein assigning, by the computer-based musical composition system, a respective mood label to each time interval includes, for a movie, assigning a respective mood label to each scene based on dynamic characteristics of each scene.

10. The method of claim 1 wherein assigning, by the computer-based musical composition system, a respective mood label to each time interval includes, for a movie, assigning a respective mood label to each scene based on semantic properties of each scene.

11. The method of claim 1 wherein for each time interval, assigning, by the computer-based musical composition system, at least one respective musical characteristic to the time interval based at least in part on the mood label assigned to the time interval and a stored mapping between mood labels and musical characteristics includes assigning at least one respective chord progression to the time interval, the at least one chord progression selected from a set of chord progressions that correspond to the mood label assigned to the time label per the mapping between mood labels and musical characteristics.

12. The method of claim 11, further comprising aligning chord progressions in abutting segments of the movie or song.

13. The method of claim 1, further comprising, for a movie, varying a volume of the musical composition over the time intervals to anti-correlate with a volume of the movie over the time intervals.

14. The method of claim 13 wherein varying the volume of the musical composition over the time intervals to anti-correlate with a volume of the movie over the time intervals comprises:
partitioning the movie into a sequence of consecutive time windows;
determining a mean sound volume for each time window;
scaling the mean sound volume of each time window to fit in a range;
determining an anti-sound volume for each time window based on the mean sound volume of each time window;
adjusting a volume of the musical composition over the time windows based on the anti-sound volume of each time window; and
combining the volume-adjusted musical composition with audio for the movie.

15. A computer program product comprising a non-transitory processor-readable storage medium storing data and/or processor-executable instructions that, when executed by at least one processor of a computer-based musical composition system, cause the computer-based musical composition system to:
segment a movie or song into a sequence of time intervals each delimited by a respective start time and a respective stop time, wherein the computer-based musical composition system stores a set of mood labels and a set of mappings between mood labels and musical characteristics;
assign a respective mood label to each time interval;
for each time interval, assign at least one respective musical characteristic to the time interval based at least in part on the mood label assigned to the time interval and a stored mapping between mood labels and musical characteristics; and
generate a musical composition that includes the sequence of time intervals and each assigned musical characteristic corresponding to each time interval.

16. The computer program product of claim 15 wherein the data and/or processor-executable instructions that, when executed by at least one processor of the computer-based musical composition system, cause the computer-based musical composition system to segment the movie or song into a sequence of time intervals, cause the computer-based musical composition system to, for a movie, segment the movie into scenes based on visual characteristics of each frame.

17. The computer program product of claim 15 wherein the data and/or processor-executable instructions that, when executed by at least one processor of the computer-based musical composition system, cause the computer-based musical composition system to assign a respective mood label to each time interval segment the movie or song into a sequence of time intervals, cause the computer-based musical composition system to, for a movie, assign a respective mood label to each scene based on a distribution of colors within each scene.

18. The computer program product of claim 15 wherein the data and/or processor-executable instructions that, when executed by at least one processor of the computer-based musical composition system, cause the computer-based musical composition system to, for each time interval, assign at least one respective musical characteristic to the time interval based at least in part on the mood label assigned to the time interval and a stored mapping between mood labels and musical characteristics, cause the computer-based musical composition system to, for each time interval, assign at least one respective chord progression to the time interval, the at least one chord progression selected from a set of chord progressions that correspond to the mood label assigned to the time label per the mapping between mood labels and musical characteristics.

19. The computer program product of claim 15 further comprising data and/or processor-executable instructions that, when executed by at least one processor of the computer-based musical composition system, cause the computer-based musical composition system to, for a movie, vary a volume of the musical composition over the time intervals to anti-correlate with a volume of the movie over the time intervals.

20. The computer program product of claim 19 wherein the data and/or processor-executable instructions that, when executed by at least one processor of the computer-based musical composition system, cause the computer-based musical composition system to, for a movie, vary a volume of the musical composition over the time intervals to anti-correlate with a volume of the movie over the time intervals, cause the computer-based musical composition system to:
partition the movie into a sequence of consecutive time windows;
determine a mean sound volume for each time window;
scale the mean sound volume of each time window to fit in a range;
determine an anti-sound volume for each time window based on the mean sound volume of each time window;
adjust a volume of the musical composition over the time windows based on the anti-sound volume of each time window; and
combine the volume-adjusted musical composition with audio for the movie.
